(19) United States
(12) Patent Application Publication
(10) Pub. No.: US 2008/0114128 A1
(43) Pub. Date: May 15, 2008

(54) Synthesis of Copolymers in the Form of a Mikto Star by Controlled Radical Polymerization

(76) Inventors: Mathias Destarac, Paris (FR); Claire Pitois, Osny (FR); Daniel Taton, Camarsac (FR); Katerina Karagianni, Paris (FR)

Correspondence Address: Jean-Louis Seugnet;RHODIA, 8 Cedar Brook Drive, CN 7500, Cranbury, NJ, 08512-7500, US

(21) Appl. No.: 11/596,169

(22) PCT Filed: May 13, 2005
(86) PCT No.: PCT/FR05/01215

§ 371 Date: Aug. 27, 2007

(30) Foreign Application Priority Data
May 14, 2004 (FR) 0405303

(51) Int. Cl. C08F 293/00

(52) U.S. Cl. 525/193; 525/50; 525/191

(57) ABSTRACT

The invention relates to a method for the preparation of copolymers in the form of a star comprising at least two types of polymer arms having a different chemical nature. The method comprises a radical polymerization phase for a composition comprising at least one cross-linking monomer, a free radical source, and at least two first generation (co)polymers having a different chemical nature and optionally a different molecular mass. The invention also relates to star copolymers which can be prepared by said method, and the uses thereof.

The present invention relates to a process for preparing copolymers in the form of a star comprising at least two types of polymer arms of different chemical natures, said process comprising a step for radical polymerization of a composition comprising:
at least one cross-linking monomer;
a source of free radicals; and
at least two first generation (co)polymers of different chemical natures and possibly of different molecular masses.

It also relates to star copolymers which can be prepared by said process and to uses thereof.

Star polymers are polymers having a central portion and arms based on polymers extending radially from said central portion. Such polymers are known to have multiple properties, possibly different from those of the polymer arms which constitute them. As an example, the viscosity in dilute solution of star macromolecules, because of their compactness, is lower than that of a linear equivalent with the same molar mass (Fetters, L. J. et al, Advances in Chemical Physics; Wiley & Sons: Vol. XCIV Ed. 1. Prigogine, S. A. Rice, John Wiley & Sons, New York, (1996)). Applications for star polymers involve their use as additives to reduce the viscosity of solvent-based formulations or in molten media (processing aid), or to improve the resistance of materials to shock. Their use can increase the dry matter content of those formulations with the advantage of reducing solvent emissions and maintaining viscosity. The fields of application which are involved and which may be cited include paints, oil wells and waste water treatment.

Three principal categories of star (co)polymers exist, according to (a) Hadjichristidis, N. J. Polym. Sci., Part A: Polym. Chem. 1999, 37, 857. (b) Hadjichristidis, N J Pitsikalis, M.; Pispas, S.; Iatrou, H.; Chem. Rev.; 2001; 101, 3747).

The first category includes star polymers constituted by homopolymer arms, generally polystyrene, poly (meth)acrylate, polydiene, polyether, polyester or polysiloxane-based.

The second category encompasses star compounds constituted by arms in the form of block copolymers, in which case they are star block copolymers usually having a core/shell type structure.

The third category concerns stars containing either polymer arms of the same type but with different lengths (asymmetric star polymers) or at least two different types of polymers emanating from the same core. In the latter case, the compounds are designated “Mikto” type star copolymers.

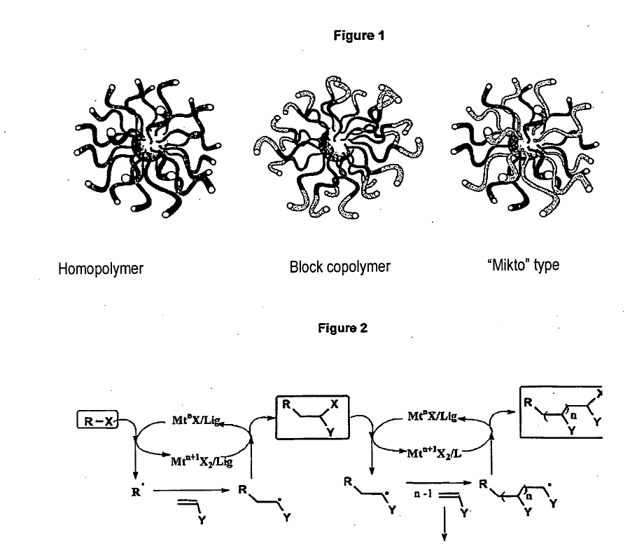

A diagrammatic representation of those various stars is shown in FIG. 1.

Processes for preparing star polymers essentially fall into two groups.

The first corresponds to the formation of polymer arms starting from a plurifunctional compound constituting the centre (“core-first” technique) (Kennedy, J P et al, Macromolecules, 29, 8631 (1996), Deffieux, A et al, Ibid, 25, 6744, (1992), Gnanou, Y et al, Ibid, 31, 6748 (1998)) and the second corresponds to a method in which the polymer chains which are to constitute the arms are first synthesized and then linked together to a core to form a star polymer (“arm-first” technique). Methods which may be used to link the arms which may in particular be cited include the method comprising reacting said arms with a compound having a plurality of functional groups which are capable of reacting with terminal antagonist functional groups of said arms (Fetters, L J et al, Macromolecules, 19, 215 (1986)), Hadjichristidis, N. et al, Macromolecules, 26, 2479 (1993), Roovers, J. et al, Macromolecules, 26, 4324 (1993)). We also cite the method comprising adding a cross-linking monomer, i.e. having a plurality of polymerizable groups and acting as a coupling agent for a solution of pre-polymer provided with an active end, followed by polymerizing said groups (the “nodule” method). After coupling, the star polymers formed are constituted by a microgel based core and arms of pre polymer radiating from that central portion (Rempp, P. Can. J. Chem. 1969, 47, 3379; Burchard, W. Makromol. Chem. 1973, 173, 235; Rempp, P. et al, Polym. Sci. Part C, 22, 145 (1968), Fetters, L. J. et al, Macromolecules, 8, 90 (1975), Higashimura et al, lbid, 24, 2309 (1991)).

To obtain polymer chains subsequently constituting the arms of those stars, methods which can control the polymerization reaction are generally employed. Living anionic and cationic polymerizations are the most widely used methods.

In particular, “Mikto” type star copolymers are generally obtained by deactivating polymer chains obtained by “living” anionic polymerization on chlorosilane type compounds or by using a coupling agent such as divinylbenzene or derivatives of 1,1-diphenylethylene (Hadjichristidis, N: J. Polym. Sci., Part A: Polym. Chem. 1999, 37, 857. (b) Hadjichristidis, N. J. Pitsikalis, M.; Pispas, S.; Latrou, H.; Chem. Rev.; 2001; 101, 3747).

However, such polymerization methods have the disadvantage of only permitting polymerization of certain types of monomers, in particular styrene and butadiene as regards anionic polymerization and vinyl ethers as regards cationic polymerization.

In addition, such polymerization techniques require a particularly pure reaction medium and temperatures which are usually below ambient temperature to minimize unwanted reactions; hence the implementation constraints are severe.

There was a need to find a way of synthesizing Mikto type stars which did not have the disadvantages cited above.

Controlled radical polymerization is a technique which can synthesize controlled or living polymers under conditions which are much easier than for living ionic polymerizations, as shown in the following documents “Controlled/Living Radical Polymerization”, ACS Symposium Series 768 Ed. K Matyjaszewski 2000, and “Advances in Controlled/Living Radical Polymerization”, ACS Symposium Series 854 Ed. K Matyjaszewski 2003.

In addition, processes for preparing star polymers have been described using a controlled radical pathway using the “core first” method from monomers such as styrene or alkyl (meth)acrylates (Gnanou, Y. et al, Macromolecules, 31, 7218 (1998), Sawamoto, M. et al, Macromolecules, 31, 6762 (1998)).

This “core-first” synthesis pathway was used to synthesize Mikto type stars. Recent documents have described the possibility of synthesizing Mikto type star copolymers by controlled radical polymerization combined with another chain polymerization method.

The following documents may be cited: Hedrick, J. L et al, Macromolecules 2001, 34, 2798; Pan, C. Y.; J. Polym. Sci. Part A: Polym. Chem. 2001, 39, 2134; Pan, C. Y. J. Polym. Sci.: Part A: Polym. Chem. 2001, 39, 437), in which the ambivalent multifunctional initiators AₙBₘ were used in tandem, the n A groups acting to polymerize a monomer by controlled radical polymerization (ATRP) and the m B groups allowing polymerization of another monomer by another polymerization method which is not a controlled radical polymerization method.

However, that method has the disadvantage of being difficult to implement since it requires prior synthesis of a plurifunctional precursor AₙBₘ. Further, the number of arms connected to the central portion remains limited to the functionality of said precursor. Thus, that method has the disadvantage of being difficult to vary the number of arms of the star at will.

The possibility of preparing star polymers by controlled radical polymerization by an “arm first” type “nodule” method has also been described.

Controlled radical polymerization techniques used to this end may employ control agents such as nitroxyls used as counter-radicals (T. Long, J Polym. Sci. Part A.: Polym. Chem. 2001, 39, 216), transition metal complexes used in Atom Transfer Radical Polymerization (ATRP) (Matyjaszewski, K. Macromolecules, 1999, 32, 4482) or agents carrying thiocarbonyl thio groups, such as dithioesters, in a reversible addition-fragmentation process (International patent application WO-A-00/02939 by BERGE et al).

However, those documents do not describe the possibility of preparing Mikto type stars. In view of the preparation processes described, the star polymers of this document can only be star homopolymers or star block copolymers.

The possibility of preparing star polymers by controlled radical polymerization using a “core first” method has also been described in the document WO-A-04/14535 by Rhodia Chimie.

In a first stage, that process comprises a step for radical polymerization of a composition comprising at least one cross-linking monomer, a source of free radicals, at least one ethylenically unsaturated monomer and a RS (C═S)Z type control agent. That step produces a branched polymer denoted a “random microgel” endowed with re-activatable ends which, in a first step, undergo chain extension by polymerization of a fresh charge of monomer. Star homopolymers or block star copolymers are thus obtained.

However, that document does not describe the possibility of preparing Mikto type stars.

Thus, one aim of the invention is to propose a novel process for synthesizing “Mikto” type star copolymers using a controlled radical pathway which is easy to carry out.

A further aim of the invention is to propose a process for synthesizing Mikto type star copolymers during which the length and/or number of arms and thus the number average molar masses of the Mikto type star polymers can be varied.

A further aim of the invention is to propose a process for controlled radical polymerization which can produce “Mikto” type star copolymers having very different mean molar masses for the arms.

A further aim is to propose a controlled radical polymerization process which can produce “Mikto” type star copolymers from a very wide range of monomers, compared with known prior art techniques.

These and other aims are achieved in the present invention which concerns a process for preparing “Mikto” type star copolymers which comprises a step for radical polymerization of a composition comprising:
at least one cross-linking monomer;
a source of free radicals; and

at least two first generation (co)polymers of different chemical natures and possibly of different molecular masses.

According to a preferred mode, the process of the invention concerns a process for preparing star copolymers comprising at least two types of polymer arms with different chemical natures, said process comprising a step for controlled radical polymerization, carried out using an Atom Transfer Radical Polymerization (ATRP) type process or a reversible thiocarbonylthio compound addition-fragmentation transfer process, of a composition (1) comprising:
at least one cross-linking monomer;
a source of free radicals; and
at least two first generation (co)polymers of different chemical natures and possibly of different molecular masses, obtained by a process which comprises a controlled radical polymerization step carried out using an Atom Transfer Radical Polymerization (ATRP) process or a reversible thiocarbonylthio compound addition-fragmentation transfer process of a composition (2) comprising:
at least one monoethylenicaly unsaturated monomer;
a source of free radicals; and
at least one control agent;
   it being understood that said process is carried out in the absence of a multiethylenically unsaturated monomer.

The process of the invention thus has the advantage of allowing the number of arms and thus the number average molar masses of the star copolymers to be varied by adjusting a certain number of the experimental parameters, including: the concentration of reagents in the reaction medium, the proportion and chemical nature of said reagents, such as the cross-linking agent or the first generation (co)polymers, and the molar mass of the first generation (co)polymer chains.

The first generation (co)polymers may be obtained by transfer or reversible termination controlled radical polymerization.

The first generation (co)polymers may be homopolymers, random copolymers (with two or more monomers) or with a composition gradient, block copolymers (di-, tri-, etc) or block copolymers in which one or more than one of the blocks is a random copolymer.

The first generation (co)polymers include:
any polymer carrying a thiocarbonylthio (dithiocarbamate, dithiocarbonate, trithiocarbonate, dithioester, thioetherthione, dithiocarbazate) at the chain end, obtained by a reversible addition-fragmentation process; or
any polymer containing a halogenated or pseudo-halogenated group at the chain end obtained by ATRP.

The synthesis of a polymer carrying a thiocarbonylthio (dithiocarbamate, dithiocarbonate, trithiocarbonate, dithioester, thioetherthione, dithiocarbazate) group at the chain end obtained by a reversible addition-fragmentation process is described in International patent applications WO-A-98/01478 by Dupont Nemours and WO-A-99/35178 by Rhodia Chimie, which use dithioester, RSC═SR′, type addition-fragmentation control (or reversible transfer) agents. A further category of control agents, the xanthates, RSC═SOR′, has been described in patent applications WO-A-98/58974, WO-A-00/75207 and WO-A-01/42312 by Rhodia Chimie as precursors for block copolymers. Further, aminooxythiocarbonylthio, R¹—S— (C═S)ONR²R³, compounds have been described as radical polymerization control agents in International patent application WO-A-03/082928 filed in the name of SYMYX.

Controlling radical polymerization with dithiocarbamates, RS(C═S)NR₁R₂, has also recently been described in patent applications WO-A-99/35177 by Rhodia and WO-A-99/31144 by Dupont Nemours. Furthermore, thioetherthione compounds have been described as radical polymerization control agents in French patent application FR-A-2 794 464 filed in the name of Rhodia Chimie. Furthermore, dithiocarbazate compounds have been described as radical polymerization control agents in International patent application WO-A-02/26836 filed in the name of SYMYX.

The synthesis of a polymer containing a halogenated or pseudo-halogenated group at the chain end obtained by ATRP is described in International patent application WO-A-96/30421 filed in the name of Carnegie Mellon University, and in the reference “Advances in Controlled/Living Radical Polymerization”, ACS Symposium Series 854 Ed. K Matyjaszewski, 2003, p. 102 and 268.

The first generation (co)polymers may be obtained in a separate and independent manner by a process which comprises a step for controlled radical polymerization of a composition comprising:
at least one monoethylenicaly unsaturated monomer;
a source of free radicals; and
at least one control agent;
   it being understood that said process is carried out in the absence of a multiethylenically unsaturated monomer.

The monoethylenically unsaturated monomers used in preparing first generation (co)polymers are all monomers which polymerize in the presence of a control agent to produce active polymer chains.

These monomers may be used regardless of the method for synthesizing the first generation (co)polymer.

The monoethylenically unsaturated monomer may, for example, have formula (I):

CXX′=CYY′ (I)

in which:
X, X′, Y, Y′ which may be identical or different, represent H, a halogen or a R₂, OR₂, 0₂COR₂, NHCOH, OH, NH₂, NHR₂, N(R₂)₂, (R₂)₂N⁺O⁻, NHCOR₂, C0₂H, C0₂R₂, CN, CONH₂, CONHR₂ or CON(R₂)₂ group, in which R₂ is selected from alkyl, aryl, aralkyl, alkylaryl, alkene and organosilyl groups, optionally perfluorinated and optionally substituted with one or more carboxy, epoxy, hydroxyl, alkoxy, amino, halogen or sulfonic groups.

Examples of these monoethylenically unsaturated monomers are:
styrene and styrene derivatives, such as alphamethylstyrene or vinyltoluene;
carboxylic acid vinyl esters such as vinyl acetate, vinyl Versatate® or vinyl propionate;
vinyl and vinylidene halides;
ethylenically unsaturated mono- and di-carboxylic acids, such as acrylic acid, methacrylic acid, itaconic acid, maleic acid, fumaric acid and mono-alkylesters of dicarboxylic acids of the type cited with alkanols preferably containing 1 to 4 carbon atoms, and their N-substituted derivatives;
unsaturated carboxylic acid amides such as acrylamide, methacrylamide, N-methylolacrylamide or methacrylamide or N-alkylacrylamides;
ethylenically unsaturated monomers comprising a sulfonic acid group and its alkaline or ammonium salts, for example vinylsulfonic acid, vinylbenzene sulfonic acid, alpha-acrylamido methylpropanesulfonic acid or 2-sulfoethylene-methacrylate;
vinylamine amides, especially vinylformamide, vinylacetamide, N-vinylpyrrolidone and N-vinylcaprolactame;
ethylenically unsaturated monomers comprising a secondary, tertiary or quaternary amino group, or a heterocyclic group containing nitrogen, such as vinylpyridines, vinylimidazole, aminoalkyl (meth)acrylates or aminoalkyl (meth)acrylamides such as dimethylaminoethyl-acrylate or -methacrylate, ditertiobutylaminoethyl-acrylate or -methacrylate, dimethylaminomethyl-acrylamide or -methacrylamide or zwitterionic monomers such as sulfopropyl (dimethyl)aminopropyl acrylate, for example;
(meth) acrylic esters such as glycidyl acrylate or glycidyl methacrylate;
vinyl nitrites;
monomers comprising at least one boronate function or a precursor selected, for example, from acryloylbenzene boronic acid, methacryloylbenzene boronic acid, 4-vinylbenzene boronic acid, 3-acrylamidophenylboronic acid or 3-methacrylamidophenylboronic acid, used alone or as a mixture, or in the form of salts;
monomers comprising phosphonates selected, for example, from N-methacrylamidomethylphosphonic acid ester derivatives, in particular n-propyl ester (RN 31857-11-1), methyl ester (RN 31857-12-2), ethyl ester (RN 31857-13-3), n-butyl ester (RN 31857-14-4), or the isopropyl ester (RN 51239-00-0), and their monobasic and dibasic phosphonic acids, such as N-methacrylamidomethylphosphonic diacid (RN 109421-20-7); N-methacrylamidoethylphosphonic acid ester derivatives such as N-methacrylamidoethyl phosphonic acid dimethyl ester (RN 266356-40-5), N-methacrylamidoethyl phosphonic acid di(2-butyl-3,3-dimethyl) ester (RN 266356-45-0), as well as their monobasic and dibasic phosphonic acid esters such as N-methacrylamidoethylphosphonic diacid (RN 80730-17-2); N-acrylamidomethylphosphonic acid ester derivatives such as N-acrylamidomethyl phosphonic acid dimethyl ester (RN 24610-95-5), N-acrylamidomethyl phosphonic acid diethyl ester (RN 24610-96-6), bis(2-chloropropyl) N-acrylamidomethyl phosphonate (RN 50283-36-8), as well as their monobasic and dibasic phosphonic acid derivatives such as N-acrylamidomethyl phosphonic acid (RN 151752-38-4); vinylbenzylphosphonate dialkyl ester derivatives, in particular di-(n-propyl) (RN 60181-26-2), di(isopropyl) (RN 159358-34-6), diethyl (RN 726-61-4), dimethyl (RN 266356-24-5), di-(2-butyl-3,3-dimethyl) (RN 266356-29-0) and di-(t-butyl) (RN 159358-33-5) ester derivatives, as well as their monobasic and dibasic phosphonic acid ester derivatives, such as vinylbenzylphosphonic diacid (RN 53459-43-1); 2-diethyl (4-vinylphenyl)ethanephosphonate (RN 61737-88-0); dialkylphosphonoalkyl acrylate and methacrylate derivatives such as 2-(acryloyloxy)ethylphosphonic acid dimethyl ester (RN 54731-78-1) and 2-(methacryloyloxy)ethylphosphonic acid dimethylester (RN 22432-83-3), 2-(methacryloyloxy)methylphosphonic acid diethylester (RN 60161-88-8), 2-(methacryloyloxy)methylphosphonic acid dimethylester (RN 63411-25-6), 2-(methacryloyloxy)propylphosphonic acid dimethylester (RN 252210-28-9), 2-(acryloyloxy)methylphosphonic acid diisopropylester (RN 51238-98-3), 2-(acryloyloxy)ethylphosphonic acid diethylester (RN 20903-86-0), as well as their monobasic and dibasic phosphonic acid variations, such as 2-(methacryloyloxy)ethylphosphonic acid (RN 80730-17-2), 2-(methacryloyloxy)methylphosphonic acid (RN 87243-97-8), 2-(methacryloyloxy) propylphosphonic acid (RN 252210-30-3), 2-(acryloyloxy) propylphosphonic acid (RN 254103-47-4) and 2-(acryloyloxy)ethylphosphonic acid; vinylphosphonic acid, optionally substituted with cyano, phenyl, ester or acetate groups, vinylidene phosphonic acid, in the form of its sodium salt or its isopropyl ester, bis(2-chloroethyl) vinylphosphonate, these monomers having a monobasic or dibasic phosphonic acid function which may be used in the partially or completely neutralized form, optionally by an amine, for example dicyclohexylamine;
monomers selected from phosphate analogues of the phosphonate monomers described above, the monomers thus comprising a —C—O—P— concatenation as opposed to the —C—P— concatenation of phosphonates; and monomers carrying an alkoxysilane function selected from trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, di-isopropoxymethylsilylpropyl methacrylate, dimethoxysilylpropyl methacrylate, diethoxysilylpropyl methacrylate, dibutoxysilylpropyl methacrylate, di-isopropoxysilylpropyl methacrylate, trimethoxysilylpropyl methacrylate, triethoxysilylpropyl methacrylate, tributoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, di-isopropoxymethylsilylpropyl acrylate, dimethoxysilylpropyl acrylate, diethoxysilylpropyl acrylate, dibutoxysilylpropyl acrylate, di-isopropoxysilylpropyl acrylate, trimethoxysilylpropyl acrylate, triethoxysilylpropyl acrylate and tributoxysilylpropyl acrylate.

The term “(meth)acrylic esters” means esters of acrylic acid and methacrylic acid with hydrogenated or fluorinated C₁-C₁₂ alcohols, preferably C₁-C₈. Compounds of this type which may be cited include: methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate and isobutyl methacrylate.

More particularly, the vinyl nitriles include those containing 3 to 12 carbon atoms, in particular acrylonitrile and methacrylonitrile.

To prepare block polyvinylamines, the preferred ethylenically unsaturated monomers used are vinylamine amides, for example vinylformamide or vinylacetamide. Next, the polymer obtained is hydrolyzed at an acidic or basic pH.

To prepare block polyvinylalcohols, the preferred ethylenically unsaturated monomers used are carboxylic acid vinyl esters, such as vinyl acetate. Next, the polymer obtained is hydrolyzed at an acidic or basic pH.

Preferably, the monoethylenically unsaturated monomers used in preparing the first generation (co)polymers are selected from styrene monomers, vinyl esters, neutral or charged hydrophilic acrylates, hydrophobic acrylates, neutral or charged hydrophilic methacrylates, hydrophobic methacrylates, hydrophilic, hydrophobic, neutral or charged acrylamido compounds, and hydrophilic, hydrophobic, neutral or charged methacrylamido compounds.

The types and quantities of polymerizable monomers employed to prepare the first generation (co)polymers varies as a function of the particular final application intended for the Mikto star copolymer. These variations are well known and may readily be determined by the skilled person.

Said monoethylenically unsaturated monomers may be used alone or as a mixture.

In all cases, the process of the invention is carried out in the presence of a source of free radicals. However, for certain monomers, such as styrene, the free radicals which can initiate polymerization may be generated by the monoethylenically unsaturated monomer at sufficiently high temperatures which are generally over 100° C. In this case, it is not necessary to add a supplemental source of free radicals.

The nature and source of the free radicals and the control agent depend on the method of synthesizing the first generation (co)polymers.

In the case in which a process of the invention is implemented by living radical polymerization of the reversible thiocarbonylthio compound addition-fragmentation transfer type, the free radical source used is generally a radical polymerization initiator. The radical polymerization initiator may be selected from initiators conventionally used in radical polymerization. It may, for example, be one of the following initiators:
tertiary butyl hydroperoxide, cumene hydroperoxide, t-butyl-peroxyacetate, t-butyl-peroxybenzoate, t-butylperoxyoctoate, t-butylperoxyneodecanoate, t-butylperoxyisobutarate, lauryl peroxide, t-amylperoxypivalate, t-butylperoxypivalate, dicumyl peroxide, benzoyl peroxide, potassium persulfate, ammonium persulfate;
azo compounds such as: 2-2′-azobis (isobutyronitrile), 2,2′-azobis(2-butanenitrile), 4,4′-azobis(4-pentanoic acid), 1,1′-azobis(cyclohexane-carbonitrile), 2-(t-butylazo)-2-cyanopropane, 2,2′-azobis[2-methyl-N-(1,1)-bis (hydroxymethyl)-2-hydroxyethyl]propionamide, 2,2′-azobis(2-methyl-N-hydroxyethyl]-propionamide, 2,2′-azobis(N,N′-dimethyleneisobutyramidine)dichloride, 2,2′-azobis (2-amidinopropane)dichloride, 2,2′-azobis (N,N′-dimethyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl] propionamide), 2,2′-azobis[2-methyl-N-(2-hydroxyethyl)propionamide], 2,2′-azobis(isobutyramide)dihydrate;
redox systems comprising combinations such as:
   mixtures of hydrogen peroxide, alkyl peroxide, peresters, percarbonates and the like and any one selected from iron salts, titanous salts, zinc formaldehyde sulfoxylate or sodium formaldehyde sulfoxylate and reducing sugars;
   persulfate, perborate or perchlorate of alkaline metals or ammonium in association with an alkali metal bisulfite such as sodium metabisulfite and reducing sugars; and
   alkali metal persulfates in association with an arylphosphinic acid, such as benzene phosphonic acid and the like, and reducing sugars.

According to one implementation of the process for preparing first generation (co)polymers of the invention, the quantity of initiator to be used is determined so that the quantity of radicals generated is at most 50 mole %, at most 20 mole % with respect to the quantity of control agent.

Control agents which may be used in radical polymerization by a reversible thiocarbonylthio compound addition-fragmentation transfer type process to prepare first generation (co)polymers which may be cited include reversible dithioester type addition-fragmentation agents with formula RSC═SR′ such as those described in patent applications WO-A-98/01478 and WO-A-99/35178, xanthates, RSC═SOR′, such as those described in patent applications WO-A-98/58974, WO-A-00/75207 and WO-A-01/42312, aminooxythiocarbonylthio compounds, R¹-S—(C═S)ONR²R³, such as those described in patent application WO-A-03/082928 filed in the name of SYMYX, dithiocarbamates with formula RS(C═S)NR₁R₂, such as those described in patent applications WO-A-99/35177 and WO-A-99/31144, thioetherthione compounds such as those described in patent application FR-A-2 794 464 filed by Rhodia Chimie, or dithiocarbazate compounds such as those described in patent application WO-A-02/26836 in the name of SYMYX.

Thus, the control agents which may be used in radical polymerization by a reversible thiocarbonylthio compound addition-fragmentation transfer type process are compounds which may have the following formula (II):

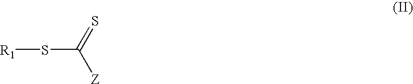

in which:
Z represents:
   a hydrogen atom;
   a chlorine atom;
   an alkyl radical, which may be substituted, or an aryl radical which may be substituted;
   a heterocycle, which may be substituted;
   an alkylthio radical, which may be substituted;
   an arylthio radical, which may be substituted;
   an alkoxy radical, which may be substituted;
   an aryloxy radical, which may be substituted;
   an amino radical, which may be substituted;
   a hydrazine radical, which may be substituted;
   an alkoxycarbonyl radical, which may be substituted;
   an aryloxycarbonyl radical, which may be substituted;
   a carboxy, acyloxy radical, which may be substituted;
   an aroyloxy radical, which may be substituted;
   a carbamoyl radical, which may be substituted
   a cyano radical;
   a dialkyl or diaryl-phosphonato radical;
   a dialkyl-phosphinato or diaryl-phosphinato radical; or
   a polymer chain;
R₁ represents:
   an alkyl, acyl, aryl, aralkyl, alkene or alkyne group, which may be substituted;
   a carbon cycle or a heterocycle, which may or may not be saturated, or aromatic, which may be substituted;
   a polymer chain;

Groups R₁ or Z, when substituted, may be substituted with phenyl groups which may be substituted, aromatic groups which may be substituted, saturated or unsaturated carbon cycles, saturated or unsaturated heterocycles or the following groups: alkoxycarbonyl or aryloxycarbonyl (—COOR), carboxy (—COOH), acyloxy (−0₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino(—NR₂), halogen, perfluoroalkyl CₙF₂ₙ₊₁, allyl, epoxy, alkoxy (—OR), S-alkyl, S-aryl, groups having a hydrophilic or ionic nature such as alkali salts of carboxylic acids, alkali salts of sulfonic acid, polyalkylene oxide chains (PEO, POP), cationic substituents (quaternary ammonium salts), R representing an alkyl or aryl group, or a polymer chain.

In a particular implementation, R₁ is an alkyl group which may or may not be substituted, preferably substituted.

Examples of compounds (A) which may be used in the present invention are compounds in which R₁ is selected from:
CH₂C₆H₅;
CH(CH₃) (CO₂Et);
CH(CH₃) (C₆H₅);
CH(CO₂)Et)₂;
C(CH₃) (CO₂Et) (S—C₆H₅);
C(CH₃)₂(C₆H₅);
C(CH₃)₂CN;
CH(CF₃)—NH(CO)CH₃;

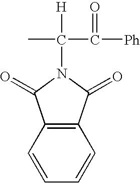

in which Et represents an ethyl group and Ph represents a phenyl group.

The alkyl, acyl, aryl, aralkyl or alkyne groups which may be substituted generally contain 1 to 20 carbon atoms, preferably 1 to 12, and more preferably 1 to 9 carbon atoms. They may be linear or branched. They may also be substituted with oxygen atoms, especially in the form of esters, sulfur atoms or nitrogen.

Alkyl radicals which may be cited include the methyl, ethyl, propyl, butyl, pentyl, isopropyl, tert-butyl, pentyl, hexyl, octyl, decyl and dodecyl radicals.

The alkyne groups are radicals generally containing 2 to 10 carbon atoms, with at least one acetylenically unsaturated bond, such as the acetylenyl radical.

The acyl group is a radical generally containing 1 to 20 carbon atoms with a carbonyl group.

Aryl radicals which may be cited include the phenyl radical, optionally substituted with a nitro or hydroxyl function.

Aralkyl radicals which may be cited include the benzyl or phenethyl radical, which may or may not be substituted, especially with a nitro or hydroxyl function.

When R₁ or Z is a polymer chain, said polymer chain may derive from radical or ionic polymerization or from polycondensation.

In the context of the present invention, the following control agents are preferred: xanthates, dithiocarbamates, dithioesters and dithiocarbazates.

Advantageously, xanthate compounds are used as the control agent.

When the first generation (co)polymers constituted by polymers with halogenated or pseudo-halogenated chain ends are obtained by the Atom Transfer Radical Polymerization (ATRP) process, the polymerization control agent is a transition metal associated with a ligand acting as the polymerization catalyst.

Examples of transition metals associated with ligands acting as a polymerization catalyst which may be cited are complexes of the CuX/2,2′-bipyridyl CuX/Schiff's base, CuX/N-alkyl-2-pyridylmethanimine, CuX/tris[2-(dimethylamino)ethyl]amine, CuX/N,N,N′,N″,N″, -pentamethyldiethylenetriamine, CuX/tris[(2-pyridyl)methyl]amine, Mn (CO)₆, RuXx (PPh₃)₃, NiX [(o-o′-CH₂NMe₂)₂C₆H₃], RhX (PPh₃)₃, NiX₂ (PPh₃)₂ and FeX₂/P (n-Bu)₃ type, in which X is a halogen or a pseudo-halogen.

An aluminum trialkylate Al(OR)₃ may be used as an additive to activate polymerization.

A detailed list of transition metals and associated ligands is given in the document WO-A-96/30421, on page 22, line 6 to page 26, line 8.

The assumed mechanism for the ATRP process is indicated in the scheme shown in FIG. 2.

The metal complex (MtnX) captures the halogen atom from the organic halide (R-X) to form the radical R^{•} and the oxidized metallic species Mtⁿ⁺¹X₂. In the next step, R reacts with the monomer M to form a new radical active species RM^{•}.

The reaction between RM^{•} and Mtⁿ⁺¹X₂ results in the formation of a potentially re-activatable species RMX and, at the same time, the metallic compound in its reduced from, MtⁿX. This can once again react with RX and promote a new redox cycle.

In the presence of a large excess of monomer M, the species RMₙX are sufficiently reactive with respect to the complex MtⁿX to promote a certain number of activation-deactivation cycles, i.e. a “living” or controlled radical polymerization reaction.

Details regarding the mechanism for this process are described in the document Macromolecules, 1995, 28, 7901.

In the case in which a process of the invention is implemented by living ATRP type radical polymerization, the source of useful free radicals used is generally an organic halide activated by the redox pathway.

Examples of organic halides acting as a source of free radicals in the ATRP process are:
an arenesulfonyl or alkanesulfonyl halide with formula RSO₂X, in which X is a chlorine atom, a bromine atom or an iodine atom and R is an aryl, alkyl, substituted alkyl or substituted aryl group. A list of groups R which fall within the context of the invention is given in the document WO-A-98/20050, for example;
a halide with formula R′X, in which X is generally a chlorine atom, a bromine atom or an iodine atom and R′ is an aryl, alkyl, substituted alkyl, substituted aryl or cycloalkyl group. A list of groups R′ which fall within the context of the invention is given in the document WO-A-96/30421, page 19 line 20 to page 22 line 5, for example, which is hereby incorporated by reference.

Preferably, the controlled radical polymerization carried out in preparing the first generation (co)polymers of the invention is carried out using a process for reversible thiocarbonylthio compound addition-fragmentation transfer. It is possible to modulate the properties of the first generation (co)polymers obtained by selecting specific monoethylenically unsaturated monomers and by selecting the order or the mode of introduction or the respective quantities of the monomers introduced.

As an example, in the case of less reactive control agents, it may be advantageous to introduce the monomer or monomers continuously.

As an example, it may be possible to provide associations within a first generation (co)polymer of neutral hydrophilic monomers with charged hydrophilic monomers, having either positive charges or negative charges.

It is also possible to provide associations within a first generation (co)polymer of hydrophilic monomers with hydrophobic monomers.

It is also possible to provide associations within a first generation (co)polymer of hard hydrophobic monomers with soft hydrophobic monomers.

The term “hard monomer” means a monomer producing a polymer with a glass transition temperature of more than 20° C.

The term “soft monomer” means a monomer producing a polymer with a glass transition temperature of less than 20° C.

It is also possible to provide associations within a first generation (co)polymer of charged monomers with neutral monomers.

After having described the preparation of first generation (co)polymers, we shall now provide details of the other ingredients used in the process for preparing Mikto type star polymers.

It will be recalled that the invention pertains to a process for preparing “Mikto” type star copolymers which comprises a step for radical polymerization of a composition comprising:
at least one cross-linking monomer;
a source of free radicals; and
at least two first generation (co)polymers of different chemical natures and possibly of different molecular masses.

The cross-linking monomers may also be added to the first generation (co)polymer alone or with one or more monoethylenically unsaturated co-monomers, or with another or a plurality of other cross-linking co-monomers.

The cross-linking monomers may be introduced all at once, in portions, by continuous addition or by semi-continuous addition.

The cross-linking monomers used in the process of the present invention are all monomers which polymerize in the presence of active polymer chains of the first generation polymer to produce new active polymer chains the controlled radical polymerization of which provides access to star polymers.

The cross-linking monomers are selected from organic compounds comprising at least two ethylenically unsaturated bonds and at most 10 unsaturated bonds and which are known to be reactive by a radical pathway.

Preferably, said monomers have two or three ethylenically unsaturated bonds.

Monomers which may especially be cited are acrylic, methacrylic, acrylamido, methacrylamido, vinyl ester, vinyl ether, diene, styrene, alpha-methyl styrene and allyl derivatives. Said monomers may also comprise functional groups other than ethylenically unsaturated bonds, for example hydroxyl, carboxy, ester, amide, amino or amino substituents, mercapto, silane, epoxy or halogeno functions.

Monomers in these categories are divinylbenzene and divinylbenzene derivatives, vinyl methacrylate, methacrylic acid anhydride, allyl methacrylate, ethylene glycol dimethacrylate, phenylene dimethacrylate, diethylene glycol dimethacrylate, triethylene glycol dimethacrylate, tetraethylene glycol dimethacrylate, polyethylene glycol 200 dimethacrylate, polyethylene glycol 400 dimethacrylate, butanediol 1,3-dimethacrylate, butanediol 1,4-dimethacrylate, hexanediol 1,6-dimethacrylate, dodecanediol 1,12-dimethacrylate, glycerol 1,3-dimethacrylate, diurethane dimethacrylate and trimethylolpropane trimethacrylate. Multifunctional acrylates which may be cited are vinyl acrylate, bisphenol A epoxy diacrylate, dipropyleneglycol diacrylate, tripropyleneglycol diacrylate, polyethylene glycol 600 diacrylate, ethylene glycol diacrylate, diethylene glycol diacrylate, triethylene glycol diacrylate, tetraethylene glycol diacrylate, ethoxylated neopentyl glycol diacrylate, butanediol diacrylate, hexanediol diacrylate, aliphatic urethane diacrylate, trimethylolpropane triacrylate, ethoxylated trimethylolpropane triacrylate, propoxylated trimethylolpropane triacrylate, propoxylated glycerol triacrylate, aliphatic urethane triacrylate, trimethylolpropane tetraacrylate and dipentaerythritol pentaacrylate. Particular vinyl ethers which may be cited are vinyl crotonate, diethylene glycol divinylether, 1,4-butanediol divinyl ether, and triethylene glycol divinylether. Allyl derivatives which may be cited are diallylphthalate, diallyldimethylammonium chloride, diallylmalleate, sodium diallyloxyacetate, diallylphenylphosphine, diallylpyrocarbonate, diallylsuccinate, N,N′-diallyltartardiamide, N,N-diallyl-2,2,2-trifluoroacetamide, the allyl ester of diallyloxyacetic acid, 1,3-diallylurea, la triallylamine, triallyltrimesate, triallylcyanurate, triallyltrimellitate and 1,3,5-triallyl-2,4,6-triazine-(1H, 3H, 5H)-trione. Acrylamido derivatives which may be cited are N,N′-methylenebisacrylamide, N,N′-methylenebismethacrylamide, glyoxalbisacrylamide and diacrylamidoacetic acid. Styrene derivatives which may be cited are divinylbenzene and 1,3-diisopropenylbenzene. Diene monomers which may be cited are butadiene, chloroprene and isoprene.

Preferred cross-linking monomers are N,N′-methylenebisacrylamide, divinylbenzene, ethylene glycol diacrylate and trimethylolpropane triacrylate.

Said cross-linking monomers may be used alone or as a mixture.

The types and quantities of the cross-linking monomers used in accordance with the present invention vary as a function of the particular final application for which the Mikto star copolymer is intended. These variations can readily be determined by the skilled person.

Preferably, the molar ratio of the cross-linking compounds with respect to the first generation polymers is 1 or more. More preferably, said molar ratio is 100 or less. More preferably again, said ratio is in the range 5 to 70, preferably in the range 5 to 20.

Said cross-linking monomers may be used alone or as a mixture.

The source of free radicals depends on the controlled radical polymerization mode used to synthesize the Mikto type star compounds. It may be selected from the list of free radical sources described in respect of the synthesis of the first generation (co)polymers for each controlled radical polymerization technique used in the present invention.

When a reversible thiocarbonylthio compound addition-fragmentation transfer type controlled radical polymerization process is used to prepare the Mikto type star copolymers, then the free radical source is a source of free radicals as defined above in respect of the preparation of first generation (co)polymers by a reversible thiocarbonylthio compound addition-fragmentation transfer type controlled radical polymerization process.

When using a controlled ATRP type radical polymerization process to prepare Mikto type star copolymers, then the free radical source is an organic halide catalyst activated by the redox pathway, as described above.

Preferably, the controlled radical polymerization process used in preparing the Mikto type star copolymer is of the reversible thiocarbonylthio compound addition-fragmentation transfer type.

The process of the invention may be carried out in the solid state, in solution, in emulsion, in dispersion or in suspension. Preferably, it is carried out in solution or in emulsion.

When it is carried out in solution, in emulsion, in dispersion or in suspension, the first generation (co)polymers may have a dry extract in the range 1% to 99.9% by weight.

When it is carried out in solution, in emulsion, in dispersion or in suspension, the dry extract of the Mikto star copolymers is advantageously in the range 1% to 30% by weight, more advantageously 5% to 20%.

The temperature may be from ambient temperature to 150° C., depending on the nature of the cross-linking monomers used.

Generally, the process for preparing Mikto type star copolymers is carried out in the absence of a UV source, by thermal initiation in the case of a reversible thiocarbonylthio compound addition-fragmentation transfer type controlled radical polymerization process or by redox initiation in the case of an ATRP type controlled radical polymerization.

It is possible to modulate the Mikto star copolymer properties obtained by selecting specific monoethylenically unsaturated monomers, which form part of the composition of the first generation (co)polymers and by selecting the order or mode of introduction or the respective quantities of the monomers introduced.

It is advantageous to introduce the cross-linking monomer in a continuous manner. Similarly, in the case in which a monoethylenically unsaturated monomer is added in addition to the cross-linking monomer as indicated above, it is preferable to add it in a continuous manner.

As an example, it is possible to provide associations within a Mikto type star of first generation (co)polymers of different chemical natures such as, for example:
hydrophilic (co)polymers associated with hydrophobic (co) polymers;
hard (co)polymers associated with soft (co)polymers;
charged (co)polymers associated with neutral (co) polymers.

The term “hard (co)polymer” means a (co)polymer with a glass transition temperature of more than 20° C.

The term “soft (co)polymer” means a (co)polymer with a glass transition temperature of less than 20° C.

The Mikto type star copolymers comprise at least two first generation (co)polymers of different chemical natures and possibly of different molecular masses. Said first generation (co)polymers may be employed in equivalent proportions or, in contrast, in very different proportions.

The first generation (co)polymers of different chemical natures may be employed in proportions of 99.9% to 0.1%, the totality of the first generation (co)polymers being equal to 100%.

It is also possible to vary the degree of branching, the number average molar masses and the density of the reactive surface functions, and as a result the form and size of said Mikto star copolymers.

These molecular characteristics may be obtained by varying a certain number of the experimental parameters including the concentration of the reaction medium, the nature of the polymerization solvent, the proportion and the chemical nature of the monoethylenically unsaturated monomers in the preparation of the first generation (co)polymers or the proportion and chemical nature of the cross-linking monomer, the proportion and the chemical nature of the control agent or the polymerization temperature.

The present invention also pertains to Mikto star copolymers which can be obtained by any one of the processes described above.

Thus, said Mikto star copolymers are characterized in that they have (1) a central portion based on a cross-linking polymer derived from polymerizing a cross-linking monomer and comprising at the chain ends the active portion of a control agent function (—S(C═S)—) in the case of a reversible thiocarbonylthio compound addition-fragmentation transfer type controlled radical polymerization process, or the halogenated or pseudo-halogenated portion in the case of an ATRP type controlled radical polymerization process; and (2) arms essentially constituted by first generation (co)polymers which have at least two different chemical natures, as defined above.

At the end of the reversible thiocarbonylthio compound addition-fragmentation transfer type controlled radical polymerization process, it is possible to at least partially deactivate the active portion of the thiocarbonylthio control agent (—S(C═S)— function) of the Mikto star copolymer using processes which are known to the skilled person.

This deactivation may thus comprise complete or partial substitution of the active portion of the thiocarbonylthio control agent (—S(C═S)— function) by a hydrogen atom or a thiol function.

These processes consist of a cleavage step as described by Mori et al. in J. Org. Chem., 34, 12, 1969, 4170 (transformation of xanthate into thiol) or that described by Udding et al. in J. Org. Chem., 59, 1994, 6671 from Bu₃SnH (transformation into halogen atom).

The Mikto star copolymers of the invention thus have a central portion based on hydrogen atoms or thiol functions which completely or partially substitute at the active portion (—S(C═S)— function) of the control agent.

Said deactivation may also be carried out by an ozonolysis treatment employing a process as described, for example, in the Applicant's patent document FR-A-03 12338.

The ends of the halogenated chains derived from the ATRP process may also be chemically modified in various manners. As an example, it is possible to cite the dehydrohalogenation reaction in the presence of an unsaturated compound, described in the patent WO-A-99/54365, which generates an unsaturated bond at the chain end. The halogenated end may also be transformed into other functions, for example by nucleophilic substitution or electrophilic addition, or by radical addition. This set of halogenated chain end transformation techniques is described in the document “Progress in Polymer Science (2001), 26(3), 337”.

The invention also concerns a Mikto star copolymer derived from reversible thiocarbonylthio compound addition-fragmentation transfer type controlled radical polymerization process in which the active portion of the control agent (—S(C═S)— function) has been at least partially deactivated at the end of polymerization.

The invention also pertains to a Mikto star copolymer derived from ATRP type controlled radical polymerization in which the active portion of the control agent has been at least partially deactivated at the end of polymerization.

The invention has particular application to a copolymer, characterized in that the (co)polymers constituting the arms are derived in particular from monoethylenically unsaturated monomers selected from vinyl esters, hydrophobic, hydrophilic, neutral or charged acrylates, hydrophobic, hydrophilic, neutral or charged methacrylates, hydrophobic, hydrophilic, neutral or charged acrylamido compounds and hydrophobic, hydrophilic, neutral or charged methacrylamido esters.

The Mikto star copolymers of the invention thus have the advantage of being able to include a large number of arms, that number being controllable during preparation thereof.

The Mikto type star copolymers may be used as additives for coating or adhesive compositions. They may also be used as additives for laundry care compositions (for example washing powders or conditioners), additives for cosmetic compositions (intended for application to the skin and/or hair and/or nails and/or eyelashes), additives for industrial compositions (emulsion polymerization, lubrication, etc) or additives for fluids for oil and/or gas field exploitation.

They may also be used as emulsifying agents, as rheological agents (agents modifying the rheological properties of a fluid, for example the viscosity), as dispersing agents, as strengthening agents for polymeric materials, as encapsulating agents, as sequestrating agents or as nano-reactors, for example in the compositions mentioned above or in other compositions.

### Emulsions and Emulsifying Agents

In an advantageous mode, the copolymers are used as emulsifying agents for the preparation of a water-in-oil inverse emulsion, an oil-in-water direct emulsion and/or a water-in-oil-in-water multiple emulsion, the star copolymer comprising first generation (co)polymers of various chemical natures selected from hydrophilic (co)polymers associated with hydrophobic (co)polymers. In the context of forming emulsions, an “oil” may also be termed the “hydrophobic phase”. The copolymers are thus versatile emulsifying agents (with a high modularity) which may be used in many types of emulsions, this constituting a surprising property. In a particular mode, the copolymers are used to prepare a water-in-oil-in-water multiple emulsion as the only emulsifying agent. This implementation simplifies the preparation of multiple emulsions, for example by having to manage fewer starting materials.

The emulsion comprises at least two non-miscible liquid phases, an internal phase and an external phase, one of which is aqueous. An emulsion comprising three non-miscible phases is not excluded, the emulsions then having an aqueous phase, a first group of droplets (first internal phase) dispersed in the external phase, and a second group of droplets (second internal phase) dispersed in the external phase. A phase (aqueous or non-aqueous) which is non-miscible with the internal phase and dispersed in the form of droplets within droplets of the internal phase is not excluded. In this case, the term often employed is “multiple emulsions”, comprising an internal emulsion and an external emulsion. As an example, they may be water-in-oil-in-water emulsions comprising an internal phase (water), an intermediate phase (oil) and an external phase. The dispersion of the internal phase in the intermediate phase constitutes an internal inverse emulsion; the dispersion of the intermediate phase in the external phase constitutes an external direct emulsion. Similarly, in the present application, the term “internal” or “external” emulsifying agent may be used. In the present application, the concept of an “inverse emulsion” encompasses a simple inverse emulsion and an internal inverse emulsion of a multiple emulsion. The concept of a “direct emulsion” encompasses a direct simple emulsion and an external direct emulsion of a multiple emulsion.

The aqueous phase may be an external phase, if necessary an external phase of a multiple emulsion. These are termed “direct emulsions”. The aqueous phase may be an internal phase, if necessary the external phase of a multiple emulsion. These are termed “inverse emulsions”. The aqueous phase clearly comprises water and other compounds If necessary. The other compounds may be solvents or co-solvents, dissolved compounds or solids dispersed in water, for example active substances. The term “other compounds” of the aqueous phase does not refer to the internal liquid phase or to the intermediate phase of a multiple emulsion.

The Mikto star copolymer is preferably dispersible or soluble in water.

The aqueous phase may also comprise compounds intended to endow the solution with a certain pH and/or salts which do not have a substantial influence on pH.

The aqueous phase may also comprise compounds routinely used in the fields of formulations in the form of emulsions or comprising emulsions, for example in laundry care fields, in cosmetics, in industrial fields (emulsion polymerization, lubrication, etc). As an example, they may be anionic, cationic, amphoteric, zwitterionic or non-ionic surfactants, detergent additives (builders), hydrophilic active ingredients, salts or viscosifying agents.

The emulsion comprises a base which is not miscible with the aqueous phase. For simplicity, this phase will be denoted the “non-aqueous phase”, the “oil phase” or the “hydrophobic phase”. The term “non-miscible phases” means a phase is no more than 10% soluble in the other phase at a temperature of 20° C. The non-aqueous phase may be the internal phase (direct emulsions) or the external phase (inverse emulsions). It may in particular be an intermediate phase of a multiple emulsion.

Examples of compounds constituting the non-aqueous phase or included in the non-aqueous phase include the following:
organic oils/fats/waxes of animal or vegetable origin;
mineral oils/waxes, for example hydrocarbon paraffins;
products derived from the alcoholysis of the above oils and possibly from subsequent esterification;
the products from trans-esterification of the oils cited above;
essential oils;
mono-, di- and tri-glycerides;
fatty acids, which may or may not be saturated, containing 10 to 40 carbon atoms; esters of said acids and alcohols containing 1 to 6 carbon atoms;
saturated or unsaturated mono-alcohols containing 2 to 40 carbon atoms;
polyols containing 2 to 10 carbon atoms;
silicones, especially aminated silicones;
hydrocarbons or hydrocarbon cuts;
water-insoluble monomers, especially those used for the polymerization of isocyanates with polyols or for latex polymerization;
precursors of water-insoluble macromonomers or resins such as alkyds or isocyanates.

Organic oils/fats/waxes of animal origin which may inter alia be cited are sperm-whale oil, whale oil, seal oil, shark oil, cod liver oil, pork fat, sheep fat (tallow), perhydrosqualene and beeswax, used alone or as a mixture. Examples of organic oils/fats/waxes of vegetable origin which may inter alia be mentioned are rapeseed oil, sunflower seed oil, peanut oil, olive oil, walnut oil, corn oil, soya oil, avocado oil, linseed oil, hemp oil, grapeseed oil, coprah oil, palm oil, cottonseed oil, babassu oil, jojoba oil, sesame seed oil, castor oil, macadamia nut oil, sweet almond oil, carnauba wax, shea butter, cocoa butter and peanut butter, used alone or as a mixture.

Mineral oils/waxes which may inter alia be cited are naphthene oils, paraffin oils (Vaseline), isoparaffin oils and paraffin waxes, used alone or as a mixture.

Products from the alcoholysis of the oils cited above may also be used.

Essential oils which may be cited in a non limiting manner are menthol oils and/or essence, spearmint, peppermint, menthol, vanilla, cinnamon, bay, aniseed, eucalyptus, thyme, sage, cedar leaf, nutmeg, citrus (lemon, lime, grapefruit, orange), fruits (apple, pear, peach, cherry, plum, strawberry, raspberry, apricot, pineapple, grape, etc), used alone or as a mixture.

The saturated or unsaturated fatty acids contain 10 to 40 carbon atoms, more particularly 18 to 40 carbon atoms, and may comprise one or more ethylenically unsaturated bonds, which may or may not be conjugated. It should be noted that said acids may include one or more hydroxyl groups.

Examples of saturated fatty acids which may be cited are palmitic, stearic and behenic acid.

Examples of unsaturated fatty acids which may be cited are myristoleic acid, palmitoleic acid, oleic acid, erucic acid, linoleic acid, linolenic acid, arachidonic acid, ricinoleic acid and mixtures thereof.

Fatty acid esters which may be cited are esters of the acids listed above, wherein the portion deriving from the alcohol contains 1 to 6 carbon atoms, such as methyl, ethyl, propyl, isopropyl esters, etc. Examples of the alcohols of these esters which may be cited are ethanol and those corresponding to the acids cited above. Suitable polyols of said esters which may be cited preferably include glycerol.

The non-aqueous phase may comprise a silicone or a mixture of several thereof. They are often termed “silicone oils”. Aminated silicones are used in particular in the detergent field. More details of silicones are given below.

In particular, it may be an oil, wax or resin of a linear, cyclic, branched or cross-linked polyorganosiloxane.

Said polyorganosiloxane preferably has a dynamic viscosity, measured at 25° C. and at a shear rate of 0.01 Hz for a force of 1500 Pa (carried out on a CSL2-500 type Carrimed®) in the range 10⁴ to 10⁹ cP.

In particular, it may be:
a non-ionic polyorganosiloxane;
a polyorganosiloxane having at least one cationic or potentially cationic function;
a polyorganosiloxane having at least one anionic or potentially anionic function;
an amphoteric polyorganosiloxane having at least one cationic or potentially cationic function and at least one anionic or potentially anionic function.

Preferably, it is a non-ionic or aminated polyorganosiloxane.

The non-aqueous phase may comprise monomers which are insoluble in water, especially those used for emulsion polymerization processes, for example for the manufacture of latex.

Finally, it should be stated that the non-aqueous phase is not prevented from comprising a quantity of water or monomers which are soluble in water which does not exceed the solubility limit in water or in the monomers of said phase.

Examples of monomers which may constitute the non-aqueous phase or be included in said phase include, used alone or as a mixture:
esters of linear, branched, cyclic or aromatic mono- or poly-carboxylic acids comprising at least one ethylenically unsaturated bond;
esters of saturated carboxylic acids containing 8 to 30 carbon atoms, optionally carrying a hydroxyl group;
α, β-ethylenically unsaturated nitrites, vinyl ethers, vinyl esters, vinylaromatic monomers, vinyl or vinylidene halides;
linear or branched, aromatic or non-aromatic hydrocarbon monomers comprising at least one ethylenically unsaturated bond;
macromonomers deriving from said monomers.

The following may in particular be cited:
esters of (meth)acrylic acid with an alcohol containing 1 to 12 carbon atoms, such as methyl (meth)acrylate, ethyl (meth)acrylate, propyl (meth)acrylate, n-butyl (meth)acrylate, t-butyl (meth)acrylate, isobutyl (meth)acrylate, 2-ethylhexyl acrylate or isodecyl acrylate;
vinyl acetate, vinyl Versatate®, vinyl propionate, vinyl chloride, vinylidene chloride, methyl vinylether or ethyl vinylether;
vinyl nitrites, more particularly including those containing 3 to 12 carbon atoms, in particular acrylonitrile and methacrylonitrile;
styrene, α-methylstyrene, vinyltoluene, butadiene and chloroprene.

It should be noted that the internal non-aqueous phase may comprise an aqueous or non-aqueous phase dispersed within it in the form of an emulsion. The emulsion is then a multiple emulsion.

The weight ratio between the quantities of internal phase and external phase is preferably in the range 0.1/99.9 to 95/5, more preferably in the range 1/99 to 10/90.

The weight ratio between the quantities of Mikto star copolymer and the internal phase is preferably in the range 0.05/100 to 20/100, more preferably in the range 0.5 to 20/100, or even in the range 5/100 to 20/100.

Further, the proportion by weight of Mikto star copolymer in the whole of the emulsion is preferably in the range 0.05% to 10%, more preferably in the range 0.1% to 5%, for example of the order of 1%.

The emulsions of the invention are compositions which may comprise other ingredients in addition to the ingredients mentioned above. The nature and quantity of those other ingredients may depend on the destination or use of the emulsion. These additional ingredients are known to the skilled person.

As an example, the emulsion may comprise known supplemental emulsifying agents, in association with the Mikto star copolymer, especially surfactants, especially non-ionic or cationic surfactants, hydrosoluble amphiphilic polymers, comb polymers or block polymers.

In the context of multiple emulsions, it should be noted that each of the aqueous phases may comprise agents intended to control the osmotic pressure. As an example, it may be a salt selected from alkali or alkaline-earth metal halides (such as sodium chloride, calcium chloride), a sugar (such as glucose) or a polysaccharide (such as dextrane) or a mixture thereof.

In general, the emulsions may comprise non-ionic, anionic, cationic or amphoteric surfactants (zwitterionic surfactants being included in the amphoteric surfactants).

The emulsions may also include pH control agents, active ingredients, fragrances, etc.

The following examples illustrate the invention without in any way limiting its scope.

### EXAMPLES

In the examples given below, the polymerization reactions were carried out with light argon flushing in simple glass apparatus immersed in an oil bath pre-heated to 70° C. The free radical generators used were 4,4′-azobis-4-cyanopentanoic acid (ACP), 2,2′-azobis-2-methylbutyronitrile (AMBN) or ammonium peroxodisulfate. The cross-linking agent used in the examples below was N,N′methylene-(bis) acrylamide (MBA). Conversion of the first generation polymer was determined by analyzing the (co)polymers by steric exclusion chromatography (SEC) or by gas chromatography (GC) for residual monomers, or by high performance liquid chromatography (HPLC). The number average molar masses Mₙ (g.mol⁻¹) were expressed as poly(ethylene oxide) equivalents for the hydrophilic polymers and as polystyrene for the hydrophobic polymers. The molar mass distribution was determined by the polymolecularity index (Iₚ) corresponding to the ratio of the mass average molar mass to the number average molar mass (Iₚ=M_{w}/Mₙ).

These examples demonstrate that the number average molar mass of first generation polymers derived from the radical polymerization of ethylenically unsaturated monomers is determined by the initial mole ratio between the monomer and the control agent. UV detection at 290 nm in GPC chromatography detected the presence of the control agent fragment at the end of the polymer chains, which was characteristic of the controlled nature of the polymerization.

### Example 1.1

### Poly (acrylic acid) prepared from xanthate EtOC(═S)SCH(CH₃)COOCH₃, [1]

2.08 g (1×10⁻² mol) of xanthate EtOC(═S)SCH(CH₃)COOCH₃ was added to 50.0 g (0.694 mol) of acrylic acid in 158.77 g of ethanol. Argon was bubbled through the reaction mixture for 20 minutes then heated to 70° C. At this temperature, 0.56 g of ACP (2×10⁻³ mol) was added dropwise over a period of 30 minutes. After reacting for 4 hours at 70° C., a second batch of 0.28 g of ACP (1×10⁻³ mol) was added to the reaction solution, and the solution was heated for 3 additional hours. Characterization of the crude product by SEC in an aqueous eluent showed the absence of residual acrylic acid. The SEC analysis gave the following values: Mₙ=6000 g.mol⁻¹ and Iₚ=1.47.

### Example 1.2

### Poly (acrylic acid) prepared from EtOC(═S)SCH(CH₃)COOCH₃, [2]

5.21 g (2.5×10⁻² mol) of xanthate EtOC(═S)SCH(CH₃)COOCH₃ was added to 50.0 g (0.694 mol) of acrylic acid in 229.24 g of ethanol. Argon was bubbled through the reaction mixture for 20 minutes then heated to 70° C. At this temperature, 1.40 g of ACP (5×10⁻³ mol) was added dropwise over a period of 60 minutes. After reacting for 4 hours at 70° C., a second batch of 0.7 g of ACP (2.5×10⁻³ mol) was added to the reaction solution, and the solution was heated for 3 additional hours. Characterization of the crude product by SEC in an aqueous eluent showed the absence of residual acrylic acid. The SEC analysis gave the following values: Mₙ=2720 g.mol⁻¹ and Iₚ=1.38.

### Example 1.3

### Butyl polyacrylate prepared from EtOC(═S)SCH(CH₃)COOCH₃, [3]

2.08 g (1×10⁻² mol) of xanthate EtOC(═S)SCH(CH₃)COOCH₃ was added to 50.0 g (0.39 mol) of butyl acrylate in 158.77 g of ethanol. Argon was bubbled through the reaction mixture for 20 minutes then heated to 70° C. At this temperature, 0.38 g of AMBN (2×10⁻³ mol) was added dropwise over a period of 30 minutes. After reacting for 4 hours at 70° C., a second batch of 0.19 g of AMBN (1×10⁻³ mol) was added to the reaction solution, and the solution was heated for 4 additional hours. Characterization of the crude product by GC showed a residual butyl acrylate content of 1%. SEC analysis in THF as the eluent gave the following values: Mₙ=4600 g.mol⁻¹ and Iₚ=1.50.

### Example 1.4

### Polyacrylamide prepared from EtOC(═S)SCH(CH₃)COOCH₃, [4]

1.46 g (7×10⁻³ mol) of xanthate EtOC(═S)SCH(CH₃)COOCH₃ was added to 166.67 g of a 30% solution of acrylamide in water, i.e. 0.70 mol of acrylamide, in a mixture comprising 31.34 g of ethanol and 8.72 g of deionized water. Argon was bubbled through the reaction mixture for 20 minutes then heated to 70° C. At this temperature, 0.39 g of ACP (1.4×10⁻³ mol) was added dropwise over a period of 30 minutes. After reacting for 4 hours at 70° C., a second batch of 0.39 g of ACP (1.4×10⁻³ mol) was added to the reaction solution, and the solution was heated for 4 additional hours. Characterization of the crude product by SEC in an aqueous eluent showed the absence of residual acrylamide. The SEC analysis gave the following values: Mₙ=5630 g.mol⁻¹ and Iₚ=1.42.

### Example 1.5

### Poly(ethyl trimethyl ammonium methyl sulfate acrylate), poly(ADAMquatMS), prepared from EtOC(═S)SCH(CH₃)COOCH₃, [5]

2.08 g (1×10⁻² mol) of xanthate EtOC(═S)SCH(CH₃)COOCH₃ was added to 62.50 g of an 80% solution of ADAMquatMS in water, i.e. 0.186 mol of ADAMquatMS, in a mixture comprising 24.73 g of ethanol and 111.43 g of deionized water. Argon was bubbled through the reaction mixture for 20 minutes then heated to 70° C. At this temperature, 0.46 g of ammonium peroxodisulfate (2×10⁻³ mol) was added dropwise over a period of 30 minutes. After reacting for 4 hours at 70° C., a second batch of 0.46 g of ammonium persulfate (2×10⁻³ mol) was added to the reaction solution, and the solution was heated for 4 additional hours. Characterization of the crude product by HPLC revealed 0.4% of residual ADAMquatMS. SEC analysis after hydrolysis of the polymer gave the following values: Mₙ=5450 g.mol⁻¹ and Iₚ=1.27.

### Example 2

### Synthesis of Copolymers in the Form of a Mikto Type Star

### Example 2.1

### Star copolymers based on poly(acrylic acid) and poly(butyl acrylate): [6]

18.5 g of the as synthesized solution of polymer [1], i.e. 5 g of polymer [1], and 20.25 g of the as synthesized solution of polymer [3], i.e. 5 g of polymer [3], were added to a reactor containing 31.50 g of tetrahydrofuran. Argon was bubbled through the reaction mixture for 20 minutes then it was heated to 70° C. At this temperature, 0.11 g of ACP (3.84×10⁻⁴ mol) was introduced, then a mixture of 2.88 g of acrylic acid (4.0×10⁻² mol) and 1.77 g of MBA (1.15×10⁻² mol) in 43.80 g of ethanol was added continuously over a period of 2 hours. Following the continuous introduction, heat was maintained for 2 h before adding a second batch of 0.11 g of ACP (3.84×10⁻⁴ mol). Finally, heat was maintained for another 4 hours. Characterization by HPLC revealed traces of MBA and GC revealed 0.2% of residual acrylic acid.

Light diffusion analysis showed a homogeneous population of polymer having a mean diameter of 69 nm. For polymer [6], the ratio “r” was about 6.

Using the same experimental conditions as for polymer [6] but varying the ratio “r” corresponding to (number of moles of MBA/number of moles of xanthate) from r=2 to 8, mean star polymer sizes from 2.9 to 69 nm respectively were obtained.

### Example 2.2

### Star Copolymers Based on Poly(Acrylamide) and Poly(Ethyl Trimethyl Ammonium Methyl Sulfate Acrylate): [7]

8.93 g of the as synthesized solution of polymer [4], i.e. 2.5 g of polymer [4], and 8.33 g of the as synthesized solution of polymer [5], i.e. 2.5 g of polymer [5], were added to a reactor containing 32.74 g of deionized water. Argon was bubbled through the reaction mixture for 20 minutes, then it was heated to 70° C. At this temperature, 0.05 g of ACP (1.79×10⁻⁴ mol) was introduced, then a mixture of 1.34 g of acrylamide (1.89×10⁻² mol) and 1.65 g of MBA (1.07×10⁻² mol) in 24.69 g of ethanol was added continuously over a period of 2 hours. Following the continuous introduction, heat was maintained for 2 h before adding a second batch of 0.05 g of ACP (1.79×10⁻⁴ mol). Finally, heat was maintained for another 4 hours. Characterization by HPLC revealed traces of MBA and GC revealed traces of residual acrylamide.

Light diffusion analysis showed a homogeneous population of polymer having a mean diameter of 91 nm.

Using the same experimental conditions as for polymer [7] but varying the ratio “r” corresponding to (number of moles of MBA/number of moles of xanthate) from r=3 to 15, mean star polymer sizes from 16 to 91 nm respectively were obtained.

### Example 2.3

### Star Copolymers Based on Poly(Acrylamide) and Poly(Acrylic Acid): [8]

0.75 g of dried polymer [2] and 7.63 g of the as synthesized solution of polymer [4], i.e. 2.14 g of polymer [4], were added to a reactor containing 20.49 g of deionized water. Argon was bubbled through the reaction mixture for 20 minutes then it was heated to 70° C. At this temperature, 0.04 g of ACP (1.5×10⁻⁴ mol) was introduced then a mixture of 1.13 g of acrylic acid (1.56×10⁻² mol) and 0.69 g of MBA (4.50×10⁻³ mol) in a mixture constituted by 12.84 g of deionized water and 4.28 g of ethanol was added continuously over a period of 2 hours. Following the continuous introduction, heat was maintained for 2 h before adding a second batch of 0.04 g of ACP (1.5×10⁻⁴ mol). Finally, heat was maintained for another 4 hours. Characterization by HPLC revealed traces of MBA, and GC revealed 0.1% of residual acrylamide.

### Example 3

### Use of Copolymers as Emulsifying Agents

### Example 3.1

### Preparation of a Water-in-Oil (w/o) Inverse emulsion

The oil used was the methyl ester of rapeseed (Phytorob 926-65 sold by Novance). The star copolymer from Example 2.1 (in which r=6) was dispersed in the oily phase in an amount of 5% by weight. Said oily phase was mixed with an aqueous solution containing 0.1 M NaCl (internal aqueous phase) with a ratio between the aqueous phase and the oil of 50/50 by weight to obtain a 50/50 w/o inverse emulsion. The mixture was sheared using an Ultra-turrax at 10000 rpm for 10 minutes.

The optical microscope showed that the droplet size in this emulsion was of the order of 1 μm.

### Example 3.2

### Preparation of a water-in-oil-in-water (w/o/w) multiple emulsion

The inverse emulsion from example 3.1 was added dropwise to an aqueous solution (external aqueous phase) comprising 0.1 M NaCl, 1% by weight of xanthan gum (Rhodopol, Rhodia) and 10% by weight of the star copolymer from example 2.1 (r=6) in a beaker, with stirring at 100 rpm using a frame blade. The quantities of inverse emulsion and aqueous solution were identical in order to obtain a 50/50 by weight emulsion of the inverse emulsion in the external aqueous phase (i.e. 25/25/50 w/o/w).

The optical microscope shows that the droplet size in said emulsion was of the order of 10-40 μm.

This example illustrates the possibility of preparing multiple water-in-oil-in-water emulsions using a single emulsifying agent which is identical whether preparing the internal water-in-oil emulsion or the external (water-in-oil) emulsion in water.

1-29. (canceled)

30. A process for preparing star copolymers comprising at least two types of polymer arms of different chemical natures, said process comprising a step for radical polymerization of a composition comprising:
at least one cross-linking monomer;
a source of free radicals; and
at least two first generation (co)polymers of different chemical natures and optionally of different molecular masses.

31. The process as claimed in claim 30, wherein the composition further comprises at least one monoethylenically unsaturated monomer.

32. The process as claimed in claim 30, wherein the first generation (co)polymers of different chemical natures are employed in proportions of 99.9% to 0.1%, the totality of the first generation (co)polymers being equal to 100%.

33. The process as claimed in claim 30, wherein the first generation (co)polymers are obtained by a process which comprises a step for radical polymerization of a composition comprising:
at least one monoethylenically unsaturated monomer;
a source of free radicals; and
at least one control agent; and
said process being carried out in the absence of a multiethylenically unsaturated monomer.

34. The process as claimed in claim 30, wherein the monoethylenically unsaturated monomer is a compound with formula (I):
CXX′=CYY′ (I)
in which:
X, X′, Y, Y′ which are identical or different, represent H, a halogen or a group R₂, OR₂, 0₂COR₂, NHCOH, OH, NH₂, NHR₂, N(R₂)₂, (R₂)₂N⁺O⁻, NHCOR₂, C0₂H, C0₂R₂, CN, CONH₂, CONHR₂ or CON(R₂)₂, in which R₂ is selected from alkyl, aryl, aralkyl, alkylaryl, alkene or organosilyl groups, optionally perfluorinated and optionally substituted with one or more carboxy, epoxy, hydroxyl, alkoxy, amino, halogen or sulfonic groups.

35. The process as claimed in claim 31, wherein the monoethylenically unsaturated monomer is:
styrene and styrene derivatives,
vinyl and vinylidene halides;
ethylenically unsaturated mono- and di-carboxylic acids, and mono-alkylesters of dicarboxylic acids;
unsaturated carboxylic acid amides;
ethylenically unsaturated monomers comprising a sulfonic acid group and its alkaline or ammonium salts;
vinylamine amides, N-vinylpyrrolidone and N-vinylcaprolactame;
ethylenically unsaturated monomers comprising a secondary, tertiary or quaternary amino group, or a heterocyclic group containing nitrogen, vinyl nitriles;
monomers having at least one boronate function or a precursor selected from the group consisting of acryloylbenzene boronic acid, methacryloylbenzene boronic acid, 4-vinylbenzene boronic acid, 3-acrylamidophenylboronic acid, and 3-methacrylamidophenylboronic acid;
monomers comprising phosphonates selected from the group consisting of N-methacrylamidomethylphosphonic acid ester derivatives, and their monobasic and dibasic phosphonic acid derivatives, as well as their monobasic and dibasic phosphonic acid esters; N-acrylamidomethylphosphonic acid ester derivatives as well as their monobasic and dibasic phosphonic acid esters, as well as their monobasic and dibasic phosphonic acid ester derivatives; and monomers carrying an alkoxysilane group selected from the group consisting of trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, di-isopropoxymethylsilylpropyl methacrylate, dimethoxysilylpropyl methacrylate, diethoxysilylpropyl methacrylate, dibutoxysilylpropyl methacrylate, di-isopropoxysilylpropyl methacrylate, trimethoxysilylpropyl methacrylate, triethoxysilylpropyl methacrylate, tributoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, di-isopropoxymethylsilylpropyl acrylate, dimethoxysilylpropyl acrylate, diethoxysilylpropyl acrylate, dibutoxysilylpropyl acrylate, di-isopropoxysilylpropyl acrylate, trimethoxysilylpropyl acrylate, triethoxysilylpropyl acrylate and tributoxysilylpropyl acrylate.

36. The process as claimed in claim 35, wherein the monoethylenically unsaturated monomer is:
alphamethylstyrene or vinyltoluene;
vinyl acetate, vinyl Versatate® or vinyl propionate;
acrylic acid, methacrylic acid, itaconic acid, maleic acid, fumaric acid;
acrylamide, methacrylamide, N-methylolacrylamide, methacrylamide, N-alkylacrylamide;
vinylsulfonic acid, vinylbenzenesulfonic acid, alpha-acrylamido methylpropanesulfonic acid, 2-sulfoethylene-methacrylate;
vinylformamide, vinylacetamide, N-vinylpyrrolidone, N-vinylcaprolactame;
vinylpyridines, vinylimidazole, dimethylaminoethyl-acrylate or -methacrylate, ditertiobutylaminoethyl-acrylate or -methacrylate, dimethylaminomethyl-acrylamide or -methacrylamide, sulfopropyl (dimethyl)aminopropyl acrylate, glycidyl acrylate or glycidyl methacrylate;
N-methacrylamidomethylphosphonic acid n-propyl ester (RN 31857-11-1), methyl ester (RN 31857-12-2), ethyl ester (RN 31857-13-3), n-butyl ester (RN 31857-14-4) or the isopropyl ester (RN 51239-00-0), N-methacrylamidomethylphosphonic diacid (RN 109421-20-7); N-methacrylamidoethyl phosphonic acid dimethyl ester (RN 266356-40-5), N-methacrylamidoethyl phosphonic acid di(2-butyl-3,3-dimethyl)ester (RN 266356-45-0), N-methacrylamidoethylphosphonic diacid (RN 80730-17-2); N-acrylamidomethyl phosphonic acid dimethyl ester (RN 24610-95-5), N-acrylamidomethyl phosphonic acid diethyl ester (RN 24610-96-6), bis(2-chloropropyl) N-acrylamidomethyl phosphonate (RN 50283-36-8), N-acrylamidomethyl phosphonic acid (RN 151752-38-4); vinylbenzylphosphonic diacid (RN 53459-43-1); 2-diethyl (4-vinylphenyl)ethanephosphonate (RN 61737-88-0); 2-(acryloyloxy)ethylphosphonic acid dimethyl ester (RN 54731-78-1) and 2-(methacryloyloxy)ethylphosphonic acid dimethylester (RN 22432-83-3), 2-(methacryloyloxy)methylphosphonic acid diethylester (RN 60161-88-8), 2-(methacryloyloxy)methylphosphonic acid dimethylester (RN 63411-25-6), 2-(methacryloyloxy)propylphosphonic acid dimethylester (RN 252210-28-9), 2-(acryloyloxy)methylphosphonic acid diisopropylester (RN 51238-98-3), 2-(acryloyloxy)acid diethylester (RN 20903-86-0), 2-(methacryloyloxy)ethylphosphonic acid (RN 80730-17-2), 2-(methacryloyloxy)methylphosphonic acid (RN 87243-97-8), 2-(methacryloyloxy)propylphosphonic acid (RN 252210-30-3), 2-(acryloyloxy)propylphosphonic acid (RN 254103-47-4) and 2-(acryloyloxy)ethylphosphonic acid; vinylphosphonic acid, optionally substituted with cyano, phenyl, ester or acetate groups, vinylidene phosphonic acid, in the form of its sodium salt or its isopropyl ester, bis(2-chloroethyl)vinylphosphonate.

37. The process as claimed in claim 35, wherein the monoethylenically unsaturated monomer is selected from the group consisting of styrene monomers, vinyl esters, hydrophobic, hydrophilic, neutral or charged acrylates, hydrophobic, hydrophilic, neutral or charged methacrylates, hydrophobic, hydrophilic, neutral or charged methacrylates, hydrophobic, hydrophilic, neutral or charged acrylamido compounds, and hydrophobic, hydrophilic, neutral or charged methacrylamido compounds.

38. The process as claimed in claim 30, wherein the controlled radical polymerization is carried out using an Atom Transfer Radical Polymerization (ATRP) process or by a reversible thiocarbonylthio compound addition-fragmentation transfer process.

39. The process as claimed in claim 38, wherein the controlled radical polymerization is carried out using a reversible thiocarbonylthio compound addition-fragmentation type transfer process.

40. The process as claimed in claim 39, wherein the thiocarbonylthio compounds are compounds with the following formula (II): 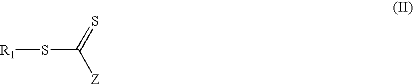
in which:
Z represents:
a hydrogen atom;
a chlorine atom;
an alkyl radical, which is substituted, or an aryl radical which is substituted;
a heterocycle, which may be substituted;
an alkylthio radical, optionally substituted;
an arylthio radical, optionally substituted;
an alkoxy radical, optionally substituted;
an aryloxy radical, optionally substituted;
an amino radical, optionally substituted;
a hydrazine radical, optionally substituted;
an alkoxycarbonyl radical, optionally substituted;
an aryloxycarbonyl radical, optionally substituted;
a carboxy, acyloxy radical, optionally substituted;
an aroyloxy radical, optionally substituted;
a carbamoyl radical, optionally substituted;
a cyano radical;
a dialkyl or diaryl-phosphonato radical;
a dialkyl-phosphinato or diaryl-phosphinato radical; or
a polymer chain;
R₁ represents:
an alkyl, acyl, aryl, aralkyl, alkene or alkyne group, optionally substituted;
a carbon cycle or a heterocycle, which may or may not be saturated, or
aromatic, optionally substituted; or
a polymer chain;

41. The process as claimed in claim 39, wherein the thiocarbonylthio compounds are xanthates, dithiocarbamates or dithioesters carrying a single function with formula —S(C═S)—.

42. The process as claimed in claim 41, wherein the compounds are xanthates.

43. The process as claimed in claim 30, wherein the cross-linking monomers are selected from organic compounds which react by a radical pathway comprising at least two ethylenically unsaturated bonds and at most 10 ethylenically unsaturated bonds.

44. The process as claimed in claim 30, wherein the cross-linking monomer is selected from acrylic, methacrylic, acrylamido, methacrylamido, vinyl ester, vinyl ether, diene, styrene, alpha-methyl styrene and allyl derivatives.

45. The process as claimed in claim 30, wherein the cross-linking monomer further comprises one or more functional groups other than the ethylenically unsaturated bonds selected from the group consisting of hydroxyl, carboxy, ester, amide, amino or substituted amino, mercapto, silane, epoxy and halogeno functions.

46. The process as claimed in claim 30, wherein the cross-linking monomer is a divinylbenzene compound, a divinylbenzene compound, vinyl methacrylate, methacrylic acid anhydride, allyl methacrylate, ethylene glycol dimethacrylate, phenylene dimethacrylate, diethylene glycol dimethacrylate, triethylene glycol dimethacrylate, tetraethylene glycol dimethacrylate, polyethylene glycol 200 dimethacrylate, polyethylene glycol 400 dimethacrylate, butanediol 1,3-dimethacrylate, butanediol 1,4-dimethacrylate, hexanediol 1,6-dimethacrylate, dodecanediol 1,12-dimethacrylate, glycerol 1,3-dimethacrylate, diurethane dimethacrylate, trimethylolpropane trimethacrylate; vinyl acrylate, bisphenol A epoxy diacrylate, dipropyleneglycol diacrylate, tripropyleneglycol diacrylate, polyethylene glycol 600 diacrylate, ethylene glycol diacrylate, diethylene glycol diacrylate, triethylene glycol diacrylate, tetraethylene glycol diacrylate, ethoxylated neopentyl glycol diacrylate, butanediol diacrylate, hexanediol diacrylate, aliphatic urethane diacrylate, trimethylolpropane triacrylate, ethoxylated trimethylolpropane triacrylate, propoxylated trimethylolpropane triacrylate, propoxylated glycerol triacrylate, aliphatic urethane triacrylate, trimethylolpropane tetraacrylate, dipentaerythritol pentaacrylate; vinyl crotonate, diethylene glycol divinylether, 1,4-butanediol divinyl ether, triethylene glycol divinyl ether; diallylphthalate, diallyldimethylammonium chloride, diallylmalleate, sodium diallyloxyacetate, diallylphenylphosphine, diallylpyrocarbonate, diallylsuccinate, N,N′-diallyltartardiamide, N,N-diallyl-2,2,2-trifluoroacetamide, the allyl ester of diallyloxyacetic acid, 1,3-diallylurea, la triallylamine, triallyltrimesate, triallylcyanurate, triallyltrimellitate, 1,3,5-triallyl-2,4,6-triazine-(1H, 3H, 5H)-trione; N,N′-methylenebisacrylamide, N,N′-methylenebismethacrylamide, glyoxalbisacrylamide, diacrylamido acetic acid; divinylbenzene and 1,3-diisopropenylbenzene; butadiene, chloroprene or isoprene.

47. The process as claimed in claim 30, wherein the cross-linking monomer is N,N′methylenebisacrylamide, divinylbenzene, ethylene glycol diacrylate, or trimethylolpropane triacrylate.

48. The process as claimed in claim 30, wherein the composition exhibits a ratio, expressed in molar equivalents of cross-linking compounds with respect to the first generation (co)polymers, of 1 or more.

49. The process as claimed in claim 48, wherein the ratio, expressed in molar equivalents of cross-linking compounds with respect to the first generation polymers, is 100 or less.

50. The process as claimed in claim 49, wherein the ratio, expressed in molar equivalents of cross-linking compounds with respect to the first generation polymers, is in the range 5 to 70, optionally 5 to 20.

51. A Mikto star copolymer made by the process of claim 30, comprising a first generation (co)polymers of different chemical natures selected from:
hydrophilic (co)polymers associated with hydrophobic (co)polymers;
hard (co)polymers associated with soft (co)polymers; and/or
charged (co)polymers associated with neutral (co)polymers.

52. A Mikto star copolymer made by the process of claim 30, having (1) a central portion based on a cross-linking polymer derived from polymerization of a cross-linking monomer and comprising at the chain ends the active portion of a control agent (—S(C═S)— function) in the case of a reversible thiocarbonylthio compound addition-fragmentation transfer controlled radical polymerization process, or the halogenated or pseudo-halogenated portion in the case of an ATRP controlled radical polymerization process; and (2) arms essentially constituted by first generation (co)polymers which have at least two different chemical natures, as defined in any one of the preceding claims.

53. The copolymer as claimed in claim 51, wherein the active portion of the control agent has been at least partially deactivated following polymerization.

54. The copolymer as claimed in claim 51, wherein the active portion of the control agent is a —S(C═S)— function and in that it has been at least partially deactivated following polymerization.

55. An additive for coating or adhesive compositions;
an additive for laundry care compositions;
additives for cosmetic compositions;
additives for fluids for oil and/or gas field exploitation;
emulsifying agents;
a rheological agent;
a dispersing agent;
a strengthening agent for polymeric materials;
an encapsulating agent; or
a sequestrating agent; comprising a Mikto star copolymer as defined in claim 51.
